(19) United States
(12) Patent Application Publication
(10) Pub. No.: US 2019/0182515 A1
(43) Pub. Date: Jun. 13, 2019

(54) APPARATUS AND METHOD FOR PROVIDING BROADCASTING SERVICE

(71) Applicant: Electronics and Telecommunications Research Institute, Daejeon (KR)

(72) Inventors: Tae-Kyoon Kim, Daejeon (KR); Dong-Joon Choi, Daejeon (KR); Eun-Hee Hyun, Daejeon (KR); Yong-Seong Cho, Daejeon (KR); Joon-Young Jung, Daejeon (KR); Heung-Mook Kim, Daejeon (KR)

(73) Assignee: Electronics and Telecommunications Research Institute, Daejeon (KR)

(21) Appl. No.: 16/191,078

(22) Filed: Nov. 14, 2018

(30) Foreign Application Priority Data
Dec. 11, 2017 (KR) 10-2017-0169520
Feb. 26, 2018 (KR) 10-2018-0023118
Jul. 9, 2018 (KR) 10-2018-0079636

(51) Int. Cl. H04N 21/238; H04L 12/28; H04N 21/61; H04N 21/6405; H04N 7/173; H04N 21/43

(52) U.S. Cl. CPC H04N 21/238; H04L 12/2801; H04N 21/6118; H04N 21/4305; H04N 21/6405; H04N 7/17309; H04N 21/6168

(57) ABSTRACT

Disclosed herein are an apparatus and method for providing a broadcasting service. The method for providing a broadcasting service is performed using a broadcasting service provision apparatus and a terminal device, and includes performing, by the broadcasting service provision apparatus and the terminal device, initialization using information acquired from a downstream signal received from a Cable Modem Termination System (CMTS), converting, by the terminal device, an upstream signal received from a Cable Modem (CM) into a digital signal, encapsulating the digital signal into an IP packet, and transmitting the IP packet to the broadcasting service provision apparatus, and extracting, by the broadcasting service provision apparatus, the digital signal from the IP packet received from the terminal device, converting the digital signal into an analog signal, and transmitting an upstream signal corresponding to the analog signal to the CMTS.

### CROSS REFERENCE TO RELATED APPLICATIONS

This application claims the benefit of Korean Patent Application Nos. 10-2017-0169520, filed Dec. 11, 2017, 10-2018-0023118, filed Feb. 26, 2018, and 10-2018-0079636, filed Jul. 9, 2018, which are hereby incorporated by reference in their entirety into this application.

### BACKGROUND OF THE INVENTION

### 1. Technical Field

The present invention relates generally to broadcasting communication technology, and more particularly, to broadcasting service provision technology and signal transmission technology using channel switching.

### 2. Description of the Related Art

A cable broadcasting network over which broadcasting service is currently provided has a Hybrid Fiber and Coaxial (HFC) structure. As the current broadcasting service, various types of services, such as 8-level Vestigial Sideband (8VSB) broadcasting service, as well as new mass broadcasting services, such as an analog broadcasting service, a digital broadcasting service, a communication service, and an Ultra-High Definition (UHD) broadcasting service, have come to be provided over a cable broadcasting network. However, the provision of services through an existing HFC-based transmission scheme has insufficient frequencies to provide broadband broadcasting services, such as a broadcasting communication service and a multi-view service, which are evolving into converged, intelligent, and personalized forms. In order to solve the problem of insufficient frequency resources, various schemes outlined below are being considered.

First, there is a frequency extension scheme. Although this scheme enables new services to be provided by utilizing a frequency band extending from an existing available frequency band and then extending the band of physically usable frequencies, it is disadvantageous in that the replacement of network and transmission equipment is required.

Second, there is a scheme using higher-order modulation/demodulation. High-order modulation/demodulation enables a larger amount of data to be transmitted than in the modulation/demodulation scheme that is currently used. Although higher-order modulation/demodulation solves the problem of insufficient frequencies by improving transmission efficiency and then increasing the total amount of data that can be transmitted per unit of reference time, it is disadvantageous in that terminals that are currently used must be replaced.

Therefore, there is a need to devise a method that can solve the problem of insufficient frequencies while minimizing the replacement of existing networks and terminals. A current broadcasting service adopts a scheme for unilaterally transmitting broadcast data regardless of whether or not a subscriber is watching the corresponding broadcast program.

In this case, a channel-switching method can efficiently use frequencies by utilizing idle frequencies, which are not used by subscribers to watch broadcasts, for channels on which a communication service is to be provided, in order to reduce the waste of frequencies. That is, the channel-switching method may use idle broadcast channel frequencies, which are not being used, by changing the idle broadcast channel frequencies to communication channel frequencies.

For example, in order to apply the channel-switching method to a Radio over Internet Protocol (RoIP) service, a message configuration and an operation method required for control between a RoIP headend and a RoIP terminal must be provided.

The RoIP service requires information about presence/absence of idle frequencies, an idle frequency band, and available time, in which a distance to a Cable Modem (CM) is taken into consideration, in order to use the channel-switching method. Here, in the RoIP service, there is a need to devise a method for configuring and operating a control message containing the above-described information.

Further, a cable broadcasting network is implemented as a Hybrid Fiber and Coaxial (HFC) network, and thus optical signals are transferred from a broadcasting station to the premises through optical cables. Here, an Optical Network Unit (ONU) may convert optical signals into electrical signals and transfer the electrical signals to the corresponding subscriber's premises through a coaxial cable. The cable broadcasting network has media characteristics that enable not only a unidirectional service for simply transmitting broadcast signals but also a bidirectional (i.e. interactive) service, such as the Internet or Voice over Internet Protocol (VoIP), using a Cable Modem (CM).

A recent cable network has evolved into a form in which optical cables are gradually extended to a location closer to a subscriber's premises and the lengths of coaxial cables are minimized or a form in which optical cables are laid all the way to the premises. In particular, Radio Frequency over Glass (RFoG) technology is technology for securing both the stability of a broadcasting service and the speed of the high-speed Internet by transferring cable broadcast signals through optical cables. The RFoG technology transfers real-time cable broadcast signals in a Radio Frequency (RF) form through an optical cable network (Fiber To The Home: FTTH) rather than through an existing HFC network for cable broadcasting, thus enabling high-speed Internet service to be provided while maintaining stable broadcasting quality of cable television (TV).

However, in order to efficiently operate an Internet Protocol (IP)-based upstream RF signal transmission system, there is required a system that converts analog upstream RF signals into digital signals and transmits the digital signals in the form of an IP packet based on an optical network in the cable broadcasting network.

The present invention is intended to propose an apparatus and method which can solve the problem of insufficient frequencies by effectively utilizing frequencies while overcoming the disadvantages of conventional technology, such as the requirement to replace networks and terminals.

Meanwhile, Korean Patent No. 10-1346983 entitled “Apparatus and Method for Transmitting Video Stream” discloses a video stream transmission/processing apparatus and method dependent on a Data over Cable Service Interface Specification (DOCSIS) headend cable modem (M-CMTS) device, which efficiently process video data streams flowing from a Hybrid Fiber Coaxial (HFC)-based cable network into a subscriber network through an IP network.

Further, Korean Patent No. 10-1347125, entitled “Interactive Cable Broadcasting System and Method”, discloses an interactive cable broadcasting system and method, which provide cable broadcast signals as downstream RF broadcast signals over an optical cable network, and use Internet data signals instead of upstream RF signals as upstream signals for requesting interactive services.

### SUMMARY OF THE INVENTION

Accordingly, the present invention has been made keeping in mind the above problems occurring in the prior art, and an object of the present invention is to solve the problem of insufficient frequencies by providing a broadcast channel, on which a subscriber does not watch a broadcast, to a communication service.

Another object of the present invention is to provide a method for efficient management, control and operation between devices which provide broadcasting services in order to improve the efficiency of channel use.

A further object of the present invention is to provide a cable broadcasting system that minimizes system construction expenses while using broadcasting equipment that is used by existing subscribers without change, even when a cable broadcasting network is changed to an optical cable network.

In accordance with an aspect of the present invention to accomplish the above objects, there is provided a method for providing a broadcasting service using a broadcasting service provision apparatus, the method including receiving a broadcasting service request from a subscriber and checking at least one of whether the subscriber is a new subscriber to a broadcast channel selected by the subscriber, whether a frequency of the broadcast channel is an idle frequency, and whether a service on the broadcast channel is an idle channel service; and assigning the subscriber to the frequency of the broadcast channel based on a result of checking at least one of whether the subscriber is a new subscriber, whether the frequency of the broadcast channel is an idle frequency, and whether the service on the broadcast channel is an idle channel service, and then providing a broadcasting service on the broadcast channel.

Checking may be configured to check whether the subscriber is a new subscriber, and is configured to, when the subscriber is an existing subscriber, request the assignment unit to cancel assignment of a broadcast channel on which the existing subscriber is watching a broadcast, and check whether the frequency of the broadcast channel is an idle frequency.

Checking may be configured to check whether the subscriber is a new subscriber, and is configured to, when the subscriber is a new subscriber, check whether the frequency of the broadcast channel is an idle frequency.

Checking may be configured to check a subscriber count value of the broadcast channel, and may be configured to, when the subscriber count value is 0, determine the frequency of the broadcast channel to be an idle frequency.

Checking may be configured to check a subscriber count value of the broadcast channel, and is configured to, when the subscriber count value is 0, determine the frequency of the broadcast channel to be an idle frequency.

Assigning the subscriber may be configured to, when the service on the broadcast channel is an idle channel service, terminate the idle channel service, and thereafter assign the subscriber to the broadcast channel, whereas when the service on the broadcast channel is not an idle channel service, assign the subscriber to the broadcast channel.

Assigning the subscriber may be configured to cancel the assignment of the subscriber to the broadcast channel by decreasing a subscriber count value previously assigned to the broadcast channel, and assign the subscriber to the broadcast channel by increasing the subscriber count value previously assigned to the broadcast channel.

In accordance with another aspect of the present invention to accomplish the above objects, there is provided an apparatus for providing a broadcasting service, including a checking unit for receiving a broadcasting service request from a subscriber and checking at least one of whether the subscriber is a new subscriber to a broadcast channel selected by the subscriber, whether a frequency of the broadcast channel is an idle frequency, and whether a service on the broadcast channel is an idle channel service; and an assignment unit for assigning the subscriber to the frequency of the broadcast channel based on a result of checking at least one of whether the subscriber is a new subscriber, whether the frequency of the broadcast channel is an idle frequency, and whether the service on the broadcast channel is an idle channel service, and then providing a broadcasting service on the broadcast channel.

The checking unit may be configured to check whether the subscriber is a new subscriber, and is configured to, when the subscriber is an existing subscriber, request the assignment unit to cancel assignment of a broadcast channel on which the existing subscriber is watching a broadcast, and check whether the frequency of the broadcast channel is an idle frequency.

The checking unit may be configured to check whether the subscriber is a new subscriber, and is configured to, when the subscriber is a new subscriber, check whether the frequency of the broadcast channel is an idle frequency.

The checking unit may be configured to check a subscriber count value of the broadcast channel, and is configured to, when the subscriber count value is 0, determine the frequency of the broadcast channel to be an idle frequency.

Here, the checking unit may be configured to, when the frequency of the broadcast channel is an idle frequency, request the assignment to assign the subscriber to the broadcast channel, whereas when the frequency of the broadcast channel is not an idle frequency, check whether the service on the broadcast channel is an idle channel service.

The assignment unit may be configured to, when the frequency of the broadcast channel is an idle frequency, assign the subscriber to the broadcast channel, whereas when the frequency of the broadcast channel is not an idle frequency, check whether the service on the broadcast channel is an idle channel service.

The assignment unit may be configured to, when the service on the broadcast channel is an idle channel service, terminate the idle channel service, and thereafter assign the subscriber to the broadcast channel, whereas when the service on the broadcast channel is not an idle channel service, assign the subscriber to the broadcast channel.

The assignment unit may cancel the assignment of the subscriber to the broadcast channel by decreasing a subscriber count value previously assigned to the broadcast channel, and assign the subscriber to the broadcast channel by increasing the subscriber count value previously assigned to the broadcast channel.

In accordance with a further aspect of the present invention to accomplish the above objects, there is provided a method for providing a broadcasting service using a broadcasting service provision apparatus and a terminal device, the method including performing, by the broadcasting service provision apparatus and the terminal device, initialization using information acquired from a downstream signal received from a Cable Modem Termination System (CMTS); converting, by the terminal device, an upstream signal received from a Cable Modem (CM) into a digital signal, encapsulating the digital signal into an IP packet, and transmitting the IP packet to the broadcasting service provision apparatus; and extracting, by the broadcasting service provision apparatus, the digital signal from the IP packet received from the terminal device, converting the digital signal into an analog signal, and transmitting an upstream signal corresponding to the analog signal to the CMTS.

Performing the initialization may include synchronizing, by the broadcasting service provision apparatus and the terminal device, a local clock using a timestamp value included in a synchronization message of the downstream signal.

Performing the initialization may be configured such that each of the broadcasting service provision apparatus and the terminal device acquires, from the downstream signal, channel information for transmitting/receiving the upstream signal, preamble information corresponding to each burst type, and upstream bandwidth allocation information.

Transmitting the IP packet to the broadcasting service provision apparatus may be configured to detect a digitized upstream RF burst signal from the digital signal using the preamble information, determine a burst type corresponding to a detection time, and acquire a clock time.

Transmitting the IP packet to the broadcasting service provision apparatus may be configured to estimate a transmitted time at which the upstream RF burst signal is transmitted based on the burst type, the clock time, and the upstream bandwidth allocation information.

Transmitting the upstream signal corresponding to the analog signal to the CMTS may be configured to extract the upstream RF burst signal from the IP packet, and acquire the transmitted time at which the upstream RF burst signal is transmitted and upstream bandwidth allocation information.

Transmitting the upstream signal corresponding to the analog signal to the CMTS may be configured to schedule a sending time at which the upstream RF burst signal is to be sent to the CMTS, based on the transmitted time at which the upstream RF burst signal is transmitted and the upstream bandwidth allocation information.

Transmitting the upstream signal corresponding to the analog signal to the CMTS may be configured to convert the upstream RF burst signal into an analog signal and transmit the upstream signal corresponding to the analog upstream RF burst signal to the CMTS.

In accordance with yet another aspect of the present invention to accomplish the above objects, there is provided a terminal device, including a terminal initialization unit for performing initialization using information acquired from a downstream signal received from a Cable Modem Termination System (CMTS); a terminal signal-processing unit for converting an upstream signal received from a Cable Modem (CM) into a digital signal and encapsulating the digital signal into an IP packet; and a terminal communication unit for receiving the downstream signal from the CMTS, receiving the upstream signal from the cable modem, and transmitting the IP packet to a broadcasting service provision apparatus.

The terminal initialization unit may synchronize a local clock using a timestamp value included in a synchronization message of the downstream signal.

The terminal initialization unit may acquire, from the downstream signal, channel information for receiving the upstream signal, preamble information corresponding to each burst type, and upstream bandwidth allocation information.

The terminal signal-processing unit may detect a digitized upstream RF burst signal from the digital signal using the preamble information, determine a burst type corresponding to a detection time, and acquire a clock time.

The terminal signal-processing unit may estimate a transmitted time at which the upstream RF burst signal is transmitted, based on the burst type, the clock time, and the upstream bandwidth allocation information.

In accordance with still another aspect of the present invention to accomplish the above objects, there is provided a headend apparatus, including a headend initialization unit for performing initialization using information acquired from a downstream signal received from a Cable Modem Termination System (CMTS); a headend signal-processing unit for extracting a digital signal from an IP packet received from a terminal device and converting the digital signal into an upstream signal corresponding to an analog signal; and a communication unit for receiving the downstream signal from the CMTS, receiving the IP packet from the terminal device, and transmitting the upstream signal to the CMTS.

The headend initialization unit may synchronize a local clock using a timestamp value included in a synchronization message of the downstream signal.

The headend initialization unit may acquire, from the downstream signal, channel information for transmitting the upstream signal, preamble information corresponding to each burst type, and upstream bandwidth allocation information.

The headend signal-processing unit may extract the upstream RF burst signal from the IP packet, and acquire a transmitted time at which the upstream RF burst signal is transmitted and the upstream bandwidth allocation information.

The headend signal-processing unit may schedule a sending time at which the upstream RF burst signal is to be sent to the CMTS, based on the transmitted time at which the upstream RF burst signal is transmitted and the upstream bandwidth allocation information.

Here, the headend signal-processing unit may convert the upstream RF burst signal into an analog signal, and transmit an upstream signal corresponding to the analog upstream RF burst signal to the CMTS through the headend communication unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a system for providing a RoIP broadcasting service according to an embodiment of the present invention;

FIG. 2 is a block diagram illustrating an apparatus for providing a broadcasting service according to an embodiment of the present invention;

FIG. 3 is a diagram illustrating a frequency channel distribution according to an embodiment of the present invention;

FIG. 4 is a diagram illustrating a changed frequency channel distribution according to an embodiment of the present invention;

FIG. 5 is a sequence diagram illustrating a method for providing a broadcasting service according to an embodiment of the present invention;

FIG. 6 is an operation flowchart illustrating a method for providing a broadcasting service according to an embodiment of the present invention;

FIG. 7 is an operation flowchart illustrating in detail an example of the frequency idleness checking step of FIG. 6;

FIG. 8 is a sequence diagram illustrating a service time and frequency allocation process in the broadcasting service provision method according to an embodiment of the present invention;

FIG. 9 is an operation flowchart illustrating a service time and frequency allocation process in the broadcasting service provision method according to an embodiment of the present invention;

FIG. 10 is a block diagram illustrating a system for providing a broadcasting service according to an embodiment of the present invention;

FIG. 11 is a block diagram illustrating a headend apparatus according to an embodiment of the present invention;

FIG. 12 is a block diagram illustrating a terminal device according to an embodiment of the present invention;

FIG. 13 is an operation flowchart illustrating a broadcasting service provision method for signal transmission between the headend apparatus and the terminal device according to an embodiment of the present invention;

FIG. 14 is an operation flowchart illustrating in detail an example of the initialization step of FIG. 13;

FIG. 15 is an operation flowchart illustrating in detail an example of the signal-processing and data transmission step of FIG. 13;

FIG. 16 is an operation flowchart illustrating in detail an example of the terminal signal-processing and data transmission step of FIG. 15;

FIG. 17 is an operation flowchart illustrating in detail an example of the headend signal-processing and data transmission step of FIG. 15;

FIG. 18 is a sequence diagram illustrating an initialization process according to an embodiment of the present invention;

FIG. 19 is a sequence diagram illustrating a data transmission process according to an embodiment of the present invention; and

FIG. 20 is a diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Hereinafter, embodiments of the present invention will be described in detail with reference to the attached drawings.

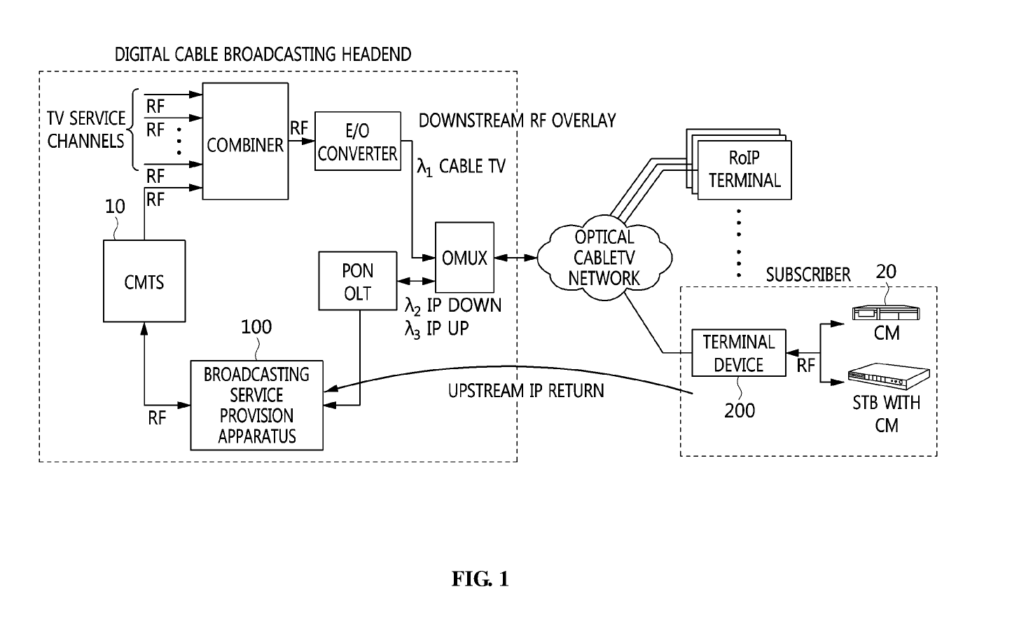

FIG. 1 is a diagram illustrating a system for providing a Radio over Internet Protocol (RoIP) broadcasting service according to an embodiment of the present invention.

Referring to FIG. 1, it can be seen that the system for providing a RoIP broadcasting service according to an embodiment of the present invention is depicted.

A broadcasting service provision system according to the embodiment of the present invention may be a cable broadcasting network system, which is the RoIP broadcasting service provision system.

The RoIP broadcasting service provision system includes a Cable Modem Termination System (CMTS), a RoIP headend, a RoIP terminal, and a Cable Modem (CM).

The RoIP broadcasting service provision system may include a terminal device 200 and a broadcasting service provision apparatus 100.

Here, the terminal device 200 may be a RoIP terminal.

The broadcasting service provision apparatus 100 may be a RoIP headend.

The subscriber-side RoIP terminal may be connected to the RoIP headend over an optical cable TV network. Broadcast signals output from an optical cable broadcasting network (i.e. Fiber To The Home: FTTH) and signals output from the Cable Modem Termination System (CMTS) may be respective RF signals in bands of different center frequencies. The RF signals may be combined into a single output by a combiner. The combiner may output an RF signal, and may convert the RF electrical signal into an optical signal through a downstream optical transmitter. The converted optical signal may be an optical Amplitude-Modulated (AM) signal for changing the intensity of a light source depending on the amplitude of the RF signal, unlike a Passive Optical Network (PON) scheme for turning on/off a light source for each bit depending on a bit value. After the signal converted into the optical signal has been amplified by an optical amplifier (e.g. Erbium-Doped Fiber Amplifier: EDFA), the amplified signal may be transmitted to a splitter through an optical cable. Signals generated from splitting by the splitter with a splitting ratio of 1:N may be input to Optical Network Terminals (ONTs) located in respective subscribers' premises.

The RoIP terminal may function as an ONT used in PON-based optical communication, and may restore the optically modulated downstream RF signal.

Here, the RoIP terminal may detect a portion, which is to be transmitted to coaxial cable equipment, and an upstream RF signal, which is output from a Set-Top Box (STB) or a Cable Modem (CM), and may digitize the portion and the upstream RF signal into digital signals and transmit the digital signals in the form of IP packets.

Unlike a downstream signal, an upstream RF signal, transmitted from the subscriber-side CM, may be converted into a digital signal by the RoIP terminal, and the resulting digital signal may then be transmitted in the form of an IP packet to an IP network (i.e. xPON network).

The RoIP headend may restore the digital signal of the received IP packet into an original analog RF signal, and may transmit the analog RF signal to the CMTS.

The RoIP headend may transmit an upstream signal in a time slot allocated to the CM from the CMTS.

For this operation, the RoIP headend may realize synchronization between the CMTS, the RoIP terminal, and the CM. Consequently, the RoIP headend and the RoIP terminal may use existing RF signal-based broadcasting equipment that is conventionally used in a cable broadcasting network, for example, existing subscriber STB and CMTS, without change.

In order to apply the concept of channel switching to the above-described RoIP broadcasting service provision system, there is required a message configuration and operation method for control between the RoIP headend and the RoIP terminal.

In order to apply the concept of channel switching to the RoIP broadcasting service provision system, frequency and time must be able to be primarily controlled and managed.

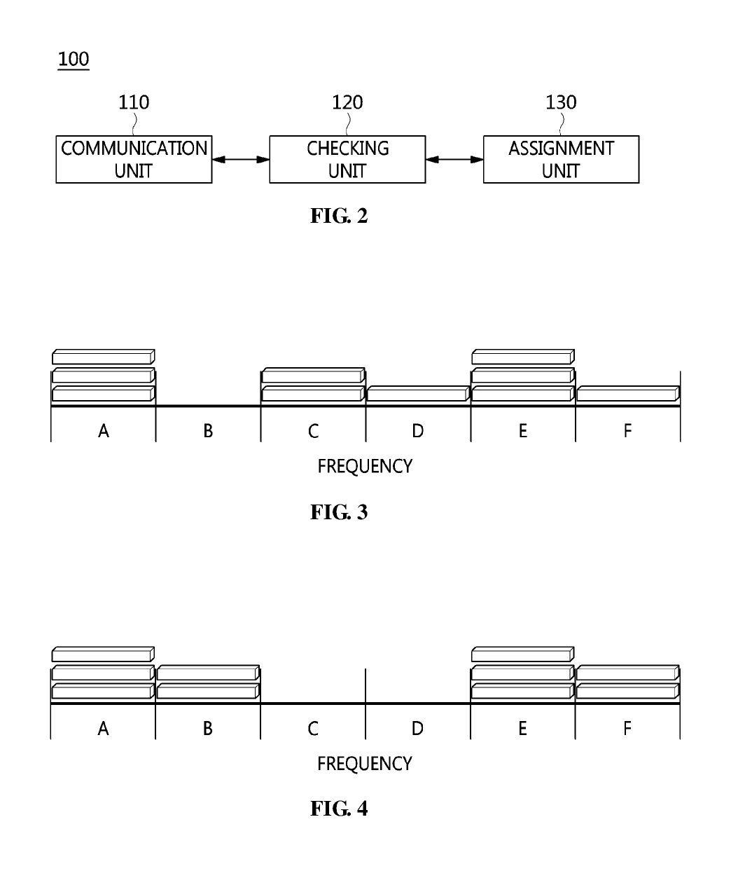

FIG. 2 is a block diagram illustrating an apparatus for providing a broadcasting service according to an embodiment of the present invention.

Referring to FIG. 2, the broadcasting service provision apparatus 100 according to the embodiment of the present invention includes a communication unit 110, a checking unit 120, and an assignment unit 130.

The communication unit 110 may receive a data packet from the terminal device 200 of a subscriber over an IP network, may convert the digital signal of the data packet into an analog signal, and may transmit the analog signal to a CMTS.

Here, the communication unit 110 may receive a broadcasting service request from the subscriber, and may forward it to the checking unit 120.

The checking unit 120 may receive the broadcasting service request from the subscriber, and may check at least one of whether the subscriber is a new subscriber to a broadcast channel selected by the subscriber, whether the frequency of the broadcast channel is an idle frequency, and whether a service on the broadcast channel is an idle channel service.

Here, the checking unit 120 may check whether the subscriber is a new subscriber, and when the subscriber is found to be an existing subscriber, may request the assignment unit 130 to cancel the assignment of a broadcast channel on which the existing subscriber is watching a broadcast, and may check whether the frequency of the broadcast channel is an idle frequency.

Here, the checking unit 120 may check the subscriber count value of the broadcast channel, and may determine the frequency of the broadcast channel to be an idle frequency when the subscriber count value is 0.

The subscriber count value CNT may correspond to a count value CNT for the channel selected by the subscriber.

The checking unit 120 may check the subscriber count value CNT of each previously assigned broadcast channel, which is managed by a database (DB) server or an internal DB.

When the subscriber count value CNT is 0, the current channel corresponds to an idle frequency at which no service is provided, and thus the communication service may be provided on the corresponding broadcast channel.

Here, the checking unit 120 may check whether the subscriber is a new subscriber, and may check whether the frequency of the broadcast channel is an idle frequency when the subscriber is a new subscriber.

When the frequency of the broadcast channel is an idle frequency, the checking unit 120 may request the assignment unit to assign a subscriber to the broadcast channel, whereas when the frequency of the broadcast channel is not an idle frequency, the checking unit 120 may check whether the service on the broadcast channel is an idle channel service.

The assignment unit 130 may assign the subscriber to the frequency of the broadcast channel based on the result of checking at least one of whether the subscriber is a new subscriber, whether the frequency of the broadcast channel is an idle frequency, and whether the service on the broadcast channel is an idle channel service, and may then provide the subscriber with a broadcasting service on the broadcast channel.

When the subscriber is an existing subscriber, the assignment unit 130 may cancel the assignment of the broadcast channel on which the existing subscriber watches a broadcast.

Here, when the subscriber is a new subscriber and the frequency of the broadcast channel is an idle frequency, the assignment unit 130 may assign the subscriber to the broadcast channel.

When the frequency of the broadcast channel is not an idle frequency and the service on the broadcast channel is an idle channel service, the assignment unit 130 may terminate the idle channel service, and then assign the subscriber to the broadcast channel. Further, when the service on the broadcast channel is not an idle channel service, the assignment unit 130 may assign the subscriber to the broadcast channel.

Here, the idle channel service may be a communication service that is currently being provided at the frequency requested by the subscriber, other than the broadcasting service.

In this case, the assignment unit 130 may cancel the assignment of a subscriber to the broadcast channel by decreasing a subscriber count value previously assigned to the broadcast channel, and may assign a subscriber to the broadcast channel by increasing the subscriber count value previously assigned to the broadcast channel.

For example, when cancelling the assignment of an existing subscriber, the assignment unit 130 may decrease the subscriber count value CNT by 1, whereas when assigning a new subscriber, the assignment unit 130 may increase the subscriber count value CNT by 1.

TABLE 1

| Command | Value | Description |
|---|---|---|
| Subscriber_ID | | Subscriber identifier |
| Current_CH_ID | 000: no exist | Currently watched channel |
| | current ch. | identifier |
| Request_CH_ID | | Watching-requested channel |
| | | identifier |
| Assign_CH | 1: ch. Assign | Watching channel assignment |

Table 1 shows a broadcasting service request message and a watching channel assignment message according to an embodiment of the present invention.

Referring to FIG. 1, the broadcasting service request message (REQ message) may include a subscriber identifier Subscriber_ID, a currently watched channel identifier Current_CH_ID, and a watching-requested channel identifier Request_CH_ID.

Here, the watching channel assignment message (RSP message) may include a subscriber identifier Subscriber_ID, a watching-requested channel identifier Request_CH_ID, and a watching channel assignment assign_CH.

Referring to Table 1, in order to manage and control channels together with each subscriber who requests a broadcasting service, an identifier subscriber_ID for identifying each subscriber who requests the broadcasting service is required.

Here, the checking unit 120 may check principal information, such as the CM version of the subscriber and the distance from the current location to the subscriber, from a server or a DB which manages subscriber information, based on the subscriber identifier of the received broadcasting service request message.

For example, when the broadcasting service provision apparatus 100 indicates a reference period for providing a service, the checking unit 120 may take into consideration an error depending on the distance to the terminal device 200 of the corresponding subscriber, and may deliver the corresponding information.

In order to check whether there is a broadcast channel on which the subscriber who requests the service is currently watching a broadcast, the checking unit 120 needs a currently watched channel identifier current_CH_ID for identifying the channel on which the subscriber is currently watching a broadcast. In this case, as the currently watched channel identifier, a value of 000 may be received when there is no channel on which the subscriber is currently watching a broadcast.

Here, the identifier request_CH_ID of the channel requested to be watched by the subscriber may be the identifier of the channel that is desired to be watched.

Here, the checking unit 120 may check whether the channel desired to be watched is a channel on which an existing service is provided.

In this case, after increasing the subscriber count value CNT of the channel desired to be watched, the assignment unit 130 may perform channel assignment assign_CH on the subscriber.

The assignment unit 130 may notify the subscriber of a service-possible time at which the service can be provided in order to provide a communication service such as the uploading of upstream data by the subscriber through the broadcast channel of the idle frequency.

The assignment unit 130 notifies the subscriber of the service-possible time, and may then provide a communication service through a changed frequency when the channel of the idle frequency is changed in response to the request from the subscriber.

That is, the assignment unit 130 may transmit information about a service provision initiation time together with frequency channel assignment information when assigning the frequency channel to the subscriber.

Here, the service provision initiation time may correspond to a reference time in the cell of a frequency band to which the subscriber belongs.

Here, the reference time must be set such that the terminal device 200 of the subscriber is synchronized with the time of the broadcasting service provision apparatus 100, and it must be possible to consider a time delay attributable to the distance to the subscriber.

That is, the assignment unit 130 must notify the terminal device 200 of the subscriber of the service-possible time at the same reference time.

Here, after transmitting service-possible time information to the subscriber, the assignment unit 130 may provide a broadcasting service to the subscriber.

The checking unit 120 may receive a request for a broadcasting service on a second broadcast channel, which corresponds to an idle frequency, from the subscriber while providing the broadcasting service to the subscriber on a first broadcast channel.

The assignment unit 130 may cancel the assignment of the subscriber to the first broadcast channel, and may assign the subscriber to the second broadcast channel, thus providing the subscriber with the broadcasting service on the second broadcast channel.

Here, when the assignment unit 130 is in a situation in which a communication service, such as the transmission of subscriber upstream data, is provided through the first broadcast channel, the assignment unit 130 may send a message for terminating the provision of the communication service through the first broadcast channel to the terminal device 200 of the subscriber.

Here, the assignment unit 130 may continue to provide the communication service to the subscriber by assigning the subscriber to the second broadcast channel, on which the broadcasting service requested by the subscriber is available.

TABLE 2

| Command | Value | Description |
|---|---|---|
| Subscriber_ID | | Subscriber identifier |
| Current_service_time | | Service time transmission |
| Assign_CH_ID | | New service-possible channel |
| | | identifier |
| New_service_time | | Transmission of service time |
| | | in newly assigned channel |

Table 2 shows a service time message and a new service channel assignment message according to an embodiment of the present invention.

Referring to Table 2, a service initiation time message (TAGN message) may notify a subscriber of service initiation time.

Here, the service initiation time message (TAGN message) may contain a subscriber identifier Subscriber_ID and a service time Current_service_time.

A new service channel assignment message (TNAN message) may contain a subscriber identifier Subscriber_ID, a new service-possible channel identifier Assign_CH_ID, and a service time on a newly assigned channel New_service_time.

Here, the new service-possible channel in Table 2 may be an idle frequency channel, and may correspond to a channel on which a communication service is currently being provided.

Since the terminal device 200 of the subscriber is in a situation which a frequency channel in use must be suddenly changed for a communication service, the terminal device 200 may receive a new frequency channel, instead of the existing frequency channel on which the communication service is provided, from the broadcasting service provision apparatus 100, and may also receive time information about the time at which the communication service can be initiated, from the broadcasting service provision apparatus 100 through the new frequency channel.

Furthermore, when the current broadcast channel cannot be further used to respond to a watching request from a subscriber, the assignment unit 130 may also provide a broadcasting service to the subscriber by assigning an additional idle frequency channel to the subscriber.

FIG. 3 is a diagram illustrating a frequency channel distribution according to an embodiment of the present invention.

Referring to FIG. 3, a frequency channel distribution according to an embodiment of the present invention may include frequency bands corresponding to bands a, b, c, d, e, and f. FIG. 4 is a diagram illustrating a changed frequency channel distribution according to an embodiment of the present invention.

Here, it can be seen that three subscribers are watching a broadcast on the corresponding channel in each of cells of frequency bands a and e (where a subscriber count value may be 3).

It can be seen that two subscribers are watching a broadcast on the corresponding channel in a cell of frequency band c (where the subscriber count value may be 2).

Here, it can be seen that one subscriber is watching a broadcast on the corresponding channel in each of cells of frequency bands d and f (where the subscriber count value may be 1).

Here, it can be seen that frequency band b is an idle frequency band that is not used by any subscriber in the cell thereof (where the subscriber count value may be 0).

Therefore, when a request is received from the subscriber, the broadcasting service provision apparatus 100 may check for an idle frequency that is not being used by any subscriber, and may allocate the frequency band b, which is the idle frequency band, to the subscriber.

Referring to FIG. 4, it can be seen that the number of subscribers assigned to the frequency channel illustrated in FIG. 3 is changed depending on the subscriber assignment scheme according to the embodiment of the present invention. That is, it can be known that, in FIG. 3, the assignment of two subscribers to frequency band c is cancelled, and two subscribers are assigned to the frequency band b.

Therefore, FIG. 4 shows that the frequency bands c and d become idle frequency bands that are not used by any subscriber in the cell thereof (where the subscriber count value may be 0).

Also, it can be seen that, in FIG. 3, the assignment of one subscriber to the frequency band d is cancelled, and one subscriber is additionally assigned to the frequency band f.

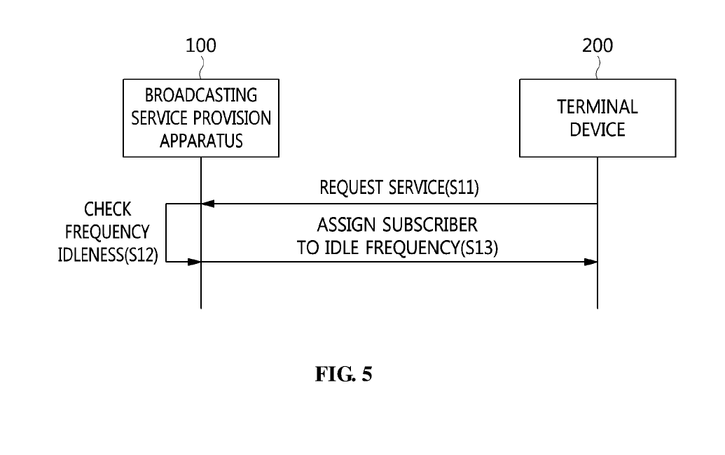

FIG. 5 is a sequence diagram illustrating the frequency allocation process of the broadcasting service provision method according to an embodiment of the present invention.

Referring to FIG. 5, in the frequency allocation process of the broadcasting service provision method according to the embodiment of the present invention, the terminal device 200 of the subscriber may request a broadcasting service from the broadcasting service provision apparatus 100 at step S11.

Here, the broadcasting service provision apparatus 100 may check a broadcast channel corresponding to an idle frequency, among frequencies of the broadcast channels, in response to the broadcasting service request received from the terminal device 200 at step S12.

Next, the broadcasting service provision apparatus 100 may assign the subscriber to the broadcast channel corresponding to the idle frequency, and may provide a broadcasting service on the corresponding broadcast channel at step S13.

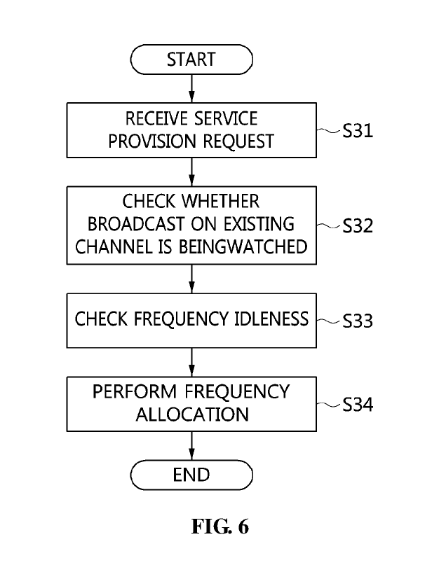

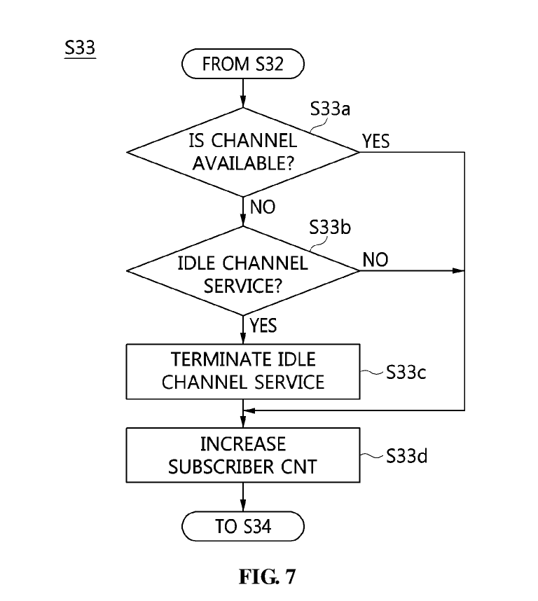

FIG. 6 is an operation flowchart illustrating a method for providing a broadcasting service according to an embodiment of the present invention. FIG. 7 is an operation flowchart illustrating in detail an example of the frequency idleness checking step of FIG. 6.

Referring to FIG. 6, the broadcasting service provision method according to the embodiment of the present invention may first receive a service provision request at step S31.

That is, at step S31, the broadcasting service provision apparatus 100 may receive the service provision request from the terminal device 200 of the subscriber.

At step S31, principal information, such as the CM version of the subscriber and the distance from the current location to the subscriber, may be checked from a server or a DB, which manages subscriber information, using the subscriber identifier of a broadcasting service request message received from the terminal device 200 of the subscriber.

For example, at step S31, when the broadcasting service provision apparatus 100 indicates a reference period for providing a service, an error attributable to the distance to the terminal device 200 of the subscriber may be taken into consideration, and then the corresponding information may be delivered.

Next, the broadcasting service provision method according to the embodiment of the present invention may check whether the subscriber is watching a broadcast on an existing channel at step S32.

That is, at step S32, whether the subscriber is a new subscriber is checked, and when the subscriber is found to be an existing subscriber, the cancelation of assignment of a broadcast channel on which the existing subscriber is watching a broadcast may be requested.

Here, at step S32, in order to check whether there is a broadcast channel on which the subscriber who requests the service is currently watching a broadcast, a currently watched channel identifier current_CH_ID for identifying the channel on which the subscriber is currently watching a broadcast (i.e., currently watched channel) is required. In this case, as the currently watched channel identifier, a value of 000 may be received when there is no channel on which the subscriber is currently watching a broadcast.

Here, the identifier request_CH_ID of the channel requested to be watched by the subscriber may be the identifier of the channel that is desired to be watched.

Here, at step S32, whether the channel desired to be watched is a broadcast channel on which an existing service is provided or a new channel may be checked.

At step S32, the subscriber count value of the existing broadcast channel is checked. When the subscriber count value is not 0, it may be determined that a broadcasting service is currently being provided to an existing subscriber, and the subscriber count value CNT of the existing broadcast channel may be decreased.

For example, at step S32, when the assignment of the existing subscriber is canceled, the subscriber count value CNT may be decreased by 1.

The subscriber count value CNT may be a count value CNT for the channel selected by the subscriber.

Here, at step S32, the subscriber count value CNT of each previously assigned broadcast channel managed by a DB server or an internal DB may be checked.

Next, the broadcasting service provision method according to the embodiment of the present invention may check frequency idleness at step S33.

Referring to FIG. 7, in a procedure at step S33, whether the corresponding channel is available may be determined at step S33a.

That is, at step S33a, whether the frequency of the broadcast channel requested by the subscriber is an idle frequency may be checked.

Here, at step S33a, the subscriber count value of the broadcast channel may be checked. When the subscriber count value is 0, the frequency of the broadcast channel may be determined to be the idle frequency.

When the subscriber count value CNT is 0, the frequency of the corresponding channel is currently an idle frequency at which no service is provided, and thus a communication service may be provided on the corresponding broadcast channel.

At step S33a, when the frequency of the broadcast channel is not an idle frequency, whether a service on the broadcast channel is an idle channel service may be checked at step S33b, whereas when the frequency of the broadcast channel is the idle frequency, the subscriber may be assigned to the broadcast channel at step S33d.

In this case, at step S33b, when the frequency of the broadcast channel is not an idle frequency, and the service on the broadcast channel is an idle channel service, the idle channel service may be terminated at step S33c.

Further, at step S33b, when the service on the broadcast channel is not an idle channel service, the subscriber may be assigned to the broadcast channel at step 33d.

Here, the idle channel service may be a communication service that is currently being provided at the frequency requested by the subscriber, other than the broadcasting service.

At step S33d, the subscriber count value CNT of the broadcast channel may be increased.

For example, at step S33d, when a new subscriber is assigned to the broadcast channel, the subscriber count value CNT may be increased by 1.

Next, the broadcasting service provision method according to the embodiment of the present invention may perform frequency allocation at step S34.

That is, at step S34, the subscriber count value CNT of the channel desired to be watched is increased, after which channel assignment (assign_CH) may be performed on the subscriber.

Here, at step S34, the broadcasting service provided on the broadcast channel corresponding to the allocated frequency may be provided to the subscriber.

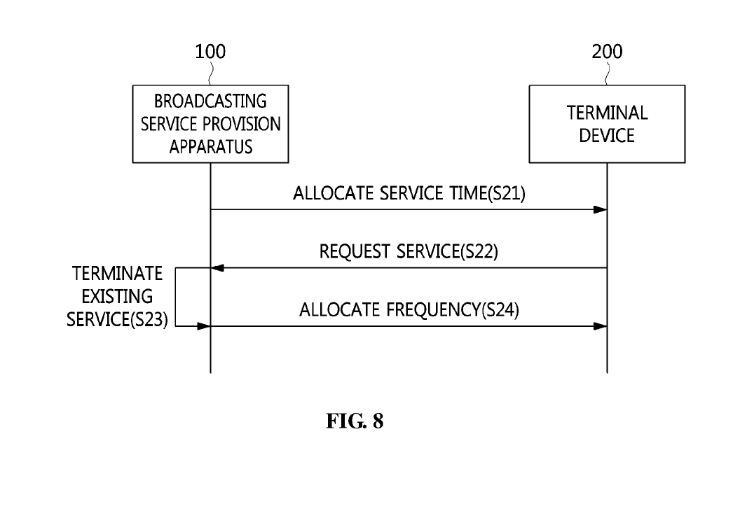

FIG. 8 is a sequence diagram illustrating a service time and frequency allocation process in the broadcasting service provision method according to an embodiment of the present invention.

Referring to FIG. 8, in the service time and frequency allocation process in the broadcasting service provision method according to the embodiment of the present invention, the broadcasting service provision apparatus 100 may allocate a service time to the terminal device 200 of the subscriber at step S21.

Here, the terminal device 200 may request an additional broadcasting service other than an existing broadcasting service that has been previously provided from the broadcasting service provision apparatus 100 with reference to the service time at step S22.

Here, the broadcasting service provision apparatus 100 may terminate the existing broadcasting service which has been provided to the subscriber at step S23.

The broadcasting service provision apparatus 100 may check for an idle frequency in relation to the requested additional broadcasting service, and may assign the subscriber to a broadcast channel corresponding to the idle frequency at step S24.

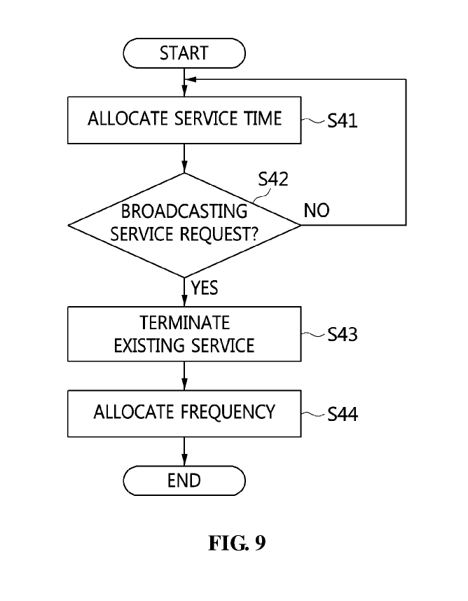

FIG. 9 is an operation flowchart illustrating a service time and frequency allocation process in the broadcasting service provision method according to an embodiment of the present invention.

First, the broadcasting service provision method according to the embodiment of the present invention may allocate a service time at step S41.

That is, at step S41, a broadcasting service time may be provided to the subscriber.

Here, at step S41, in order to provide a communication service, such as the uploading of upstream data by the subscriber through the broadcast channel of the idle frequency, notification of a service-possible time may be provided to the subscriber.

Here, at step S41, the subscriber is notified of the service-possible time, so that when an idle frequency channel is changed in response to a request from the subscriber, the communication service may be provided through the changed idle frequency channel.

At step S41, when the frequency channel is assigned to the subscriber, information about a service provision initiation time may also be transmitted together with the frequency channel.

Here, the service provision initiation time may correspond to a reference time within a cell of a frequency band to which the subscriber belongs.

Here, the reference time must be set such that the terminal device 200 of the subscriber is synchronized with the time of the broadcasting service provision apparatus 100, and it must be possible to consider a time delay attributable to the distance to the terminal device 200 of the subscriber.

Here, at step S41, the notification of a service-possible time which is the same reference time may be provided to the terminal device 200 of the subscriber.

Next, the broadcasting service provision method according to the embodiment of the present invention may check a broadcasting service request received from the subscriber at step S42.

Here, at step S42, a request for a broadcasting service on an idle frequency channel, which is a second broadcast channel on which the corresponding broadcasting service is provided, may be received from the subscriber while the broadcasting service is being provided to the subscriber on a first broadcast channel.

Here, at step S42, when the request for the broadcasting service is not received, the time of another broadcasting service may be provided to the subscriber at step S41, whereas when the request for the broadcasting service is received, the existing service may be terminated at step S43.

Next, the broadcasting service provision method according to the embodiment of the present invention may terminate the existing service at step S43.

That is, at step S43, the assignment of the subscriber to the first broadcast channel on which the existing broadcasting service is provided may be cancelled, and the broadcasting service on the first broadcast channel may be terminated.

Here, at step S43, when there is a situation in which a communication service, such as the transmission of upstream data by the subscriber, is provided on the first broadcast channel, a message for terminating the provision of the communication service on the first broadcast channel may be sent to the terminal device 200 of the subscriber.

Next, the broadcasting service provision method according to the embodiment of the present invention may allocate a frequency at step S44.

That is, at step S44, whether the second broadcast channel on which the broadcasting service requested by the subscriber is provided is an idle frequency channel is determined, and then the subscriber may be assigned to the second broadcast channel.

Here, at step S44, the subscriber may be assigned to the second broadcast channel, and the communication service may be provided to the subscriber.

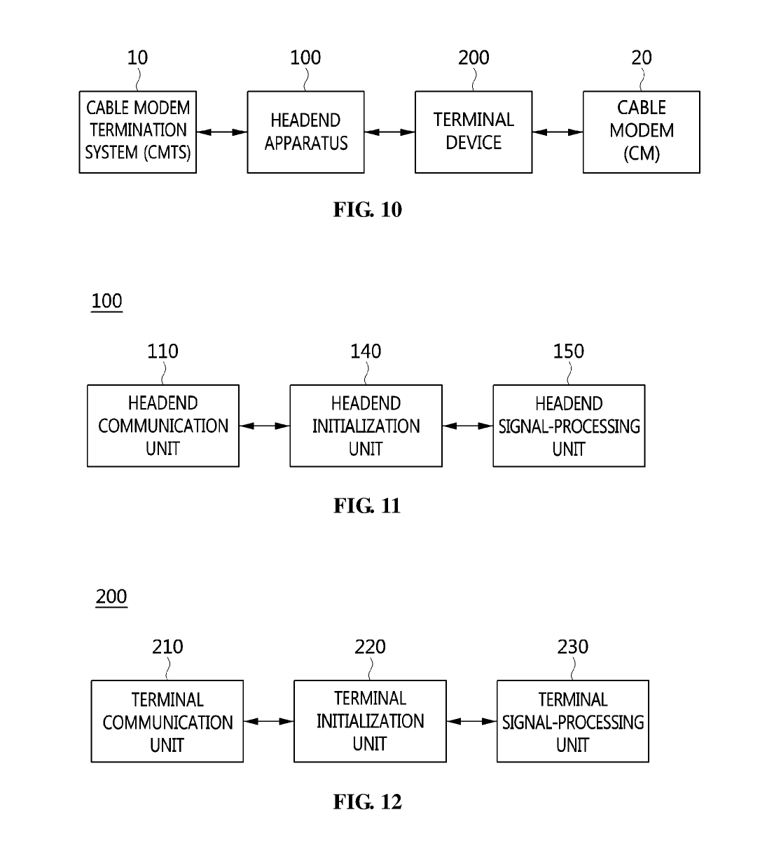

FIG. 10 is a block diagram illustrating a system for providing a broadcasting service according to an embodiment of the present invention.

Referring to FIG. 10, the broadcasting service provision system according to the embodiment of the present invention may include a Cable Modem Termination system (CMTS) 10, a headend apparatus 100, a terminal device 200, and a cable modem (CM) 20.

The headend apparatus 100 may be a RoIP headend.

Here, the headend apparatus 100 may be a broadcasting service provision apparatus 100 according to an embodiment of the present invention.

The terminal device 200 may be a RoIP terminal.

The subscriber-side RoIP terminal may be connected to the RoIP headend over an optical cable TV network. Broadcast signals output from an optical cable broadcasting network (i.e. Fiber To The Home: FTTH) and signals output from the CMTS may be respective RF signals in bands of different center frequencies. The RF signals may be combined into a single output by a combiner. The combiner may output an RF signal, and may convert the RF electrical signal into an optical signal through a downstream optical transmitter. The converted optical signal may be an optical Amplitude-Modulated (AM) signal for changing the intensity of a light source depending on the amplitude of the RF signal, unlike a Passive Optical Network (PON) scheme for turning on/off a light source for each bit depending on a bit value. After the signal converted into the optical signal has been amplified by an optical amplifier (e.g. Erbium-Doped Fiber Amplifier: EDFA), the amplified signal may be transmitted to a splitter through an optical cable. Signals generated from splitting by the splitter with a splitting ratio of 1:N may be input to Optical Network Terminals (ONTs) located in respective subscribers' premises.

The RoIP terminal may function as an ONT used in PON-based optical communication, and may restore the optically modulated downstream RF signal.

Here, the RoIP terminal may detect a portion, which is to be transmitted to coaxial cable equipment, and an upstream RF signal, which is output from a Set-Top Box (STB) or a Cable Modem (CM), and may digitize the portion and the upstream RF signal into digital signals and transmit the digital signals in the form of IP packets.

Unlike a downstream signal, an upstream RF signal, transmitted from the subscriber-side CM, may be converted into a digital signal by the RoIP terminal, and the resulting digital signal may then be transmitted in the form of an IP packet to an IP network (i.e. xPON network).

The RoIP headend may restore the digital signal of the received IP packet into an original analog RF signal, and may transmit the analog RF signal to the CMTS.

The RoIP headend may transmit an upstream signal in a time slot allocated to the CM from the CMTS.

For this operation, the RoIP headend may realize synchronization between the CMTS, the RoIP terminal, and the CM. Consequently, the RoIP headend and the RoIP terminal may use existing RF signal-based broadcasting equipment that is conventionally used in a cable broadcasting network, for example, existing subscriber STB and CMTS, without change.

FIG. 11 is a block diagram illustrating a headend apparatus according to an embodiment of the present invention.

Referring to FIG. 11, the headend apparatus 100 according to the embodiment of the present invention includes a headend communication unit 110, a headend initialization unit 140, and a headend signal-processing unit 150.

Here, the broadcasting service provision apparatus according to the embodiment of the present invention may further include the headend initialization unit 140 and the headend signal-processing unit 150, illustrated in FIG. 11, in addition to the configuration including the communication unit 110, the checking unit 120, and the assignment unit 130 illustrated in FIG. 2.

Here, the communication unit 110 illustrated in FIG. 2 may correspond to the headend communication unit 110 of FIG. 11, and may include the function of the communication unit 110 described with reference to FIG. 2.

The headend communication unit 110 may receive a downstream signal from a Cable Modem Termination System (CMTS) 10, receive an IP packet from the terminal device 200, and transmit an upstream signal to the CMTS 10.

The headend initialization unit 140 may perform initialization using information acquired from the downstream signal received from the CMTS 10.

Here, the headend initialization unit 140 may synchronize a local clock using a timestamp value contained in the synchronization message of the downstream signal.

The headend initialization unit 140 may acquire, from the downstream signal, channel information for transmitting the upstream signal, preamble information corresponding to each burst type, and upstream bandwidth allocation information.

The headend signal-processing unit 150 may extract the digital signal from the IP packet received from the terminal device 200, and may convert the digital signal into an upstream signal corresponding to an analog signal.

Here, the headend signal-processing unit 150 may extract an upstream RF burst signal from the IP packet, and may acquire information about the time at which the upstream RF burst signal is transmitted (i.e. transmitted time information) and the upstream bandwidth allocation information.

At this time, the headend signal-processing unit 150 may schedule the time at which the upstream RF burst signal is to be sent to the CMTS (i.e. sending time) based on the time at which the upstream RF burst signal is transmitted (i.e. transmitted time) and the upstream bandwidth allocation information.

Here, the headend signal-processing unit 150 may convert the upstream RF burst signal into an analog signal, and may transmit the upstream signal corresponding to the analog upstream RF burst signal to the CMTS through the headend communication unit.

FIG. 12 is a block diagram illustrating a terminal device according to an embodiment of the present invention.

Referring to FIG. 12, the terminal device 200 according to the embodiment of the present invention includes a terminal communication unit 210, a terminal initialization unit 220, and a terminal signal-processing unit 230.

The terminal communication unit 210 may receive a downstream signal from the CMTS 10, receive an upstream signal from the Cable Modem (CM) 20, and transmit an IP packet to the headend apparatus 100.

The terminal initialization unit 220 may perform initialization using information acquired from the downstream signal received from the CMTS 10.

Here, the terminal initialization unit 220 may synchronize a local clock using a timestamp value contained in the synchronization message of the downstream signal.

The terminal initialization unit 220 may acquire, from the downstream signal, channel information for receiving the upstream signal, preamble information corresponding to each burst type, and upstream bandwidth allocation information.

The terminal signal-processing unit 230 may convert the upstream signal received from the CM 20 into a digital signal, and may encapsulate the digital signal into an IP packet.

Here, the terminal signal-processing unit 230 may detect a digitized upstream RF burst signal from the digital signal using the preamble information, set a burst type for detection time, and acquire a clock time.

Here, the terminal signal-processing unit 230 may estimate the time (transmitted time) at which the upstream RF burst signal is transmitted, based on the burst type, the clock time, and the upstream bandwidth allocation information.

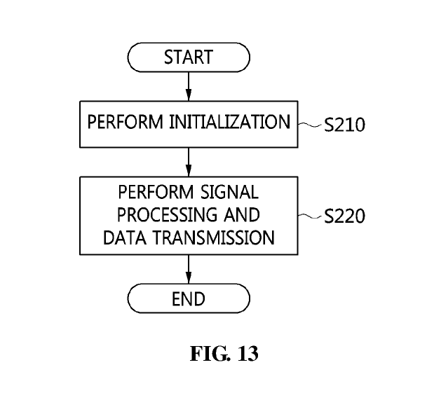

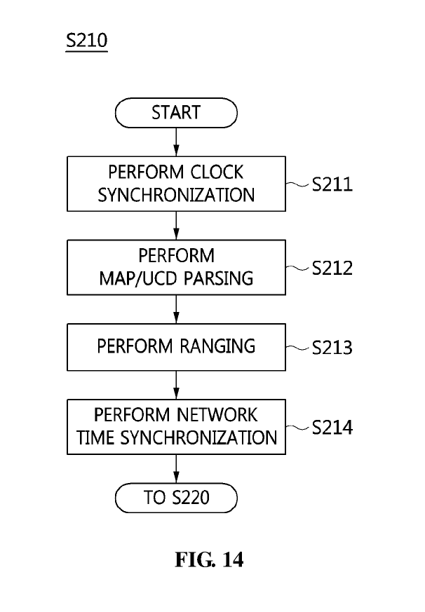

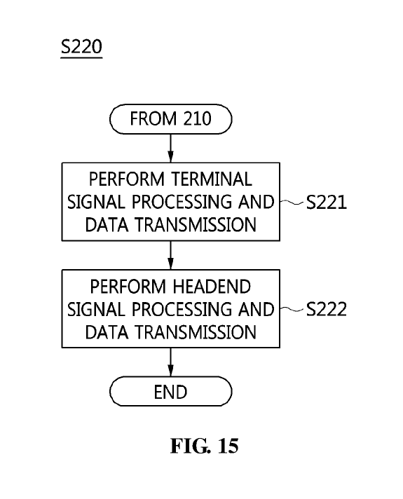

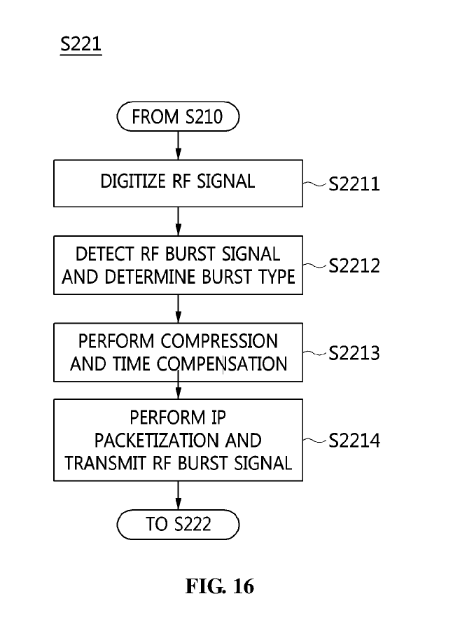

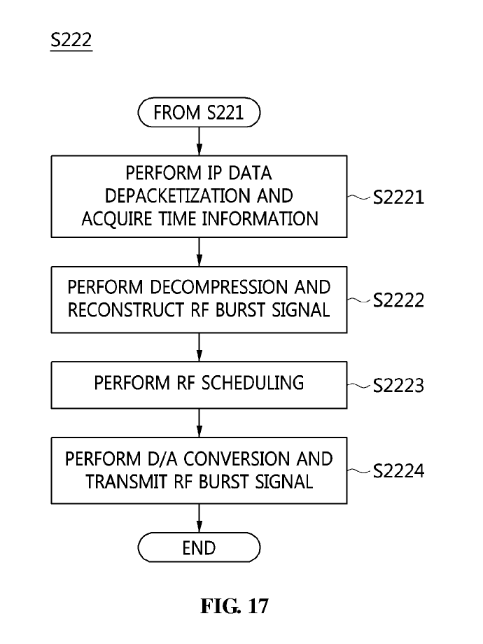

FIG. 13 is an operation flowchart illustrating a broadcasting service provision method for signal transmission between the headend apparatus and the terminal device according to an embodiment of the present invention. FIG. 14 is an operation flowchart illustrating in detail an example of the initialization step of FIG. 13. FIG. 15 is an operation flowchart illustrating in detail an example of the signal-processing and data transmission step of FIG. 13. FIG. 16 is an operation flowchart illustrating in detail an example of the terminal signal-processing and data transmission step of FIG. 15. FIG. 17 is an operation flowchart illustrating in detail an example of the headend signal-processing and data transmission step of FIG. 15.

Referring to FIG. 13, in the broadcasting service provision method according to the embodiment of the present invention, the headend apparatus 100 and the terminal device 200 may perform initialization at step S210.

That is, at step S210, initialization may be performed using information acquired from a downstream signal received from the CMTS 10.

Referring to FIG. 14, in a procedure at step S210, clock synchronization may be performed at step S211.

That is, at step S211, the headend apparatus 100 and the terminal device 200 may synchronize a local clock using a timestamp value contained in the synchronization message (SYNC message) of the downstream signal.

Here, the downstream signal may correspond to a Data-Over-Cable Service Interface Specifications (DOCSIS) downstream signal.

Further, in the procedure at step S210, a Media Access Protocol (MAP)/Upstream Channel Descriptor (UCD) message may be parsed from the downstream signal at step S212.

That is, at step S212, the headend apparatus 100 and the terminal device 200 may parse header information in the frame of a Media Access Control (MAC) management message of the downstream signal, and may acquire information for rescheduling of the upstream signal from a Bandwidth Allocation Map (Media Access Protocol)/Upstream Channel Descriptor (MAP/UCD) message.

In this case, at step S212, channel information for transmitting/receiving the upstream signal, preamble information corresponding to each burst type, and upstream bandwidth allocation information may be acquired from the downstream signal.

The upstream signal may correspond to a DOCSIS upstream signal.

Also, in the procedure at step S210, ranging may be performed at step S213.

That is, at step S213, the headend apparatus 100 may perform ranging for designating an upstream channel to be used between the headend apparatus 100 and the CMTS 10.

At this time, at step S213, the headend apparatus 100 may request ranging from the CMTS 10, and the CMTS 10 may respond to ranging requested by the headend apparatus 100.

Next, in the procedure at step S210, network time synchronization may be performed at step S214.

That is, at step S214, the headend apparatus 100 may perform network time synchronization after performing ranging.

Further, in the signal transmission method according to the embodiment of the present invention, the headend apparatus 100 and the terminal device 200 may perform signal processing and data transmission at step S220.

Referring to FIG. 15, in a procedure at step S220, first, the terminal device 200 may process a terminal signal, and may transmit data at step S221.

That is, at step S221, the terminal device 200 may convert the upstream signal received from the CM 20 into a digital signal, encapsulate the digital signal into an IP packet, and transmit the IP packet to the headend apparatus 100.

Referring to FIG. 16, in a procedure at step S221, first, digitization of the RF signal may be performed at step S2211.

That is, at step S2211, the upstream signal received from the CM 20 may be converted into an upstream RF burst signal, which is a digitized signal.

Also, in the procedure at step S221, an RF burst signal may be detected, and a burst type may be determined at step S2212.

That is, at step S2212, the digitized upstream RF burst signal may be detected from the digital signal using the preamble information (i.e. preamble pattern acquired from the UCD), a burst type for the detection time may be determined, and a clock time may be acquired.

Further, in the procedure at step S221, compression and time compensation may be performed at step S2213.

That is, at step S2213, the upstream RF burst signal may be compressed into a digital signal.

Here, at step S2213, the time at which the upstream RF burst signal is transmitted (transmitted time) may be estimated and compensated for using the burst type, the clock time, and the upstream bandwidth allocation information.

Further, in the procedure at step S221, IP packetization may be performed, and the RF burst signal may be transmitted at step S2214.

That is, at step S2214, the digital signal may be encapsulated into an IP packet, and then the IP packet may be transmitted to the headend apparatus 100.

Here, at step S2214, the digitized upstream RF burst signal and the estimated transmitted time may be encapsulated into an IP packet.

Thereafter, in the procedure at step S220, the headend apparatus 100 may process a headend signal, and may transmit data at step S222.

That is, in the procedure at step S222, the headend apparatus 100 may extract the digital signal from the IP packet received from the terminal device 200, convert the digital signal into an analog signal, and transmit the upstream signal corresponding to the analog signal to the CMTS 10.

Referring to FIG. 17, in a procedure at step S222, first, IP data depacketization may be performed, and time information may be acquired at step S2221.

That is, at step S2221, the upstream RF burst signal may be extracted from the IP packet, and the time at which the upstream RF burst signal is transmitted (transmitted time) and the upstream bandwidth allocation information may be acquired.

In the procedure at step S222, decompression may be performed, and the RF burst signal may be reconstructed at step S2222.

That is, at step S2222, the upstream RF burst signal, which has been compressed into the digital signal in the IP packet, may be decompressed, and a digitized upstream RF burst signal may be reconstructed.

In the procedure at step S222, RF scheduling may be performed at step S2223.

That is, at step S2223, the time at which the upstream RF burst signal is to be sent to the CMTS 10 (sending time) may be scheduled based on the time at which the upstream RF burst signal is transmitted (transmitted time) and the upstream bandwidth allocation information.

Next, in the procedure at step S222, D/A conversion may be performed, and the RF burst signal may be transmitted at step S2224.

That is, at step S2224, the digitized upstream RF burst signal may be converted into an analog upstream RF signal, and an upstream signal corresponding to the analog upstream RF signal may be transmitted to the CMTS 10.

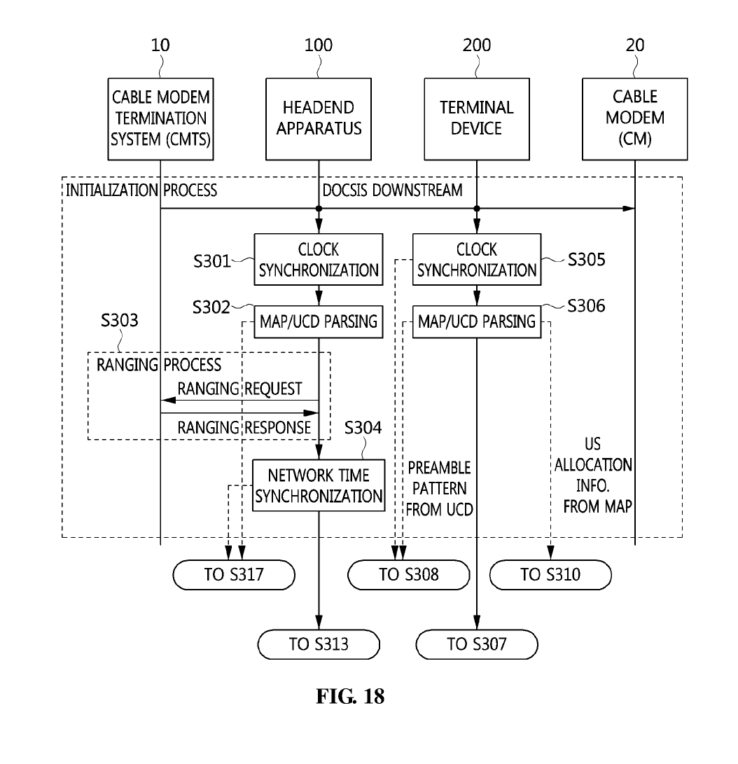

FIG. 18 is a sequence diagram illustrating an initialization process according to an embodiment of the present invention.

Referring to FIG. 18, in the initialization process according to the embodiment of the present invention, the headend apparatus 100 may perform clock synchronization at step S301.

That is, at step S301, the headend apparatus 100 may perform clock synchronization using information that is acquired from a downstream signal received from the CMTS 10.

Here, at step S301, a local clock may be synchronized using a timestamp value contained in the synchronization message (SYNC message) of the downstream signal.

Here, the downstream signal may be a DOCSIS downstream signal.

That is, at step S302, a Media Access Protocol (MAP)/Upstream Channel Descriptor (UCD) message may be parsed from the downstream signal.

That is, at step S302, the headend apparatus 100 may parse header information in the frame of a Media Access Control (MAC) management message of the downstream signal, and may acquire information for rescheduling of an upstream signal from a Bandwidth Allocation Map (Media Access Protocol)/Upstream Channel Descriptor (MAP/UCD) message.

In this case, at step S302, channel information for transmitting the upstream signal to the CMTS 10, preamble information corresponding to each burst type, and upstream bandwidth allocation information may be acquired from the downstream signal.

The upstream signal may be a DOCSIS upstream signal.

Also, at step S303, ranging may be performed.

That is, at step S303, the headend apparatus 100 may perform ranging for designating an upstream channel to be used between the headend apparatus 100 and the CMTS 10.

At this time, at step S303, the headend apparatus 100 may request ranging from the CMTS 10, and the CMTS 10 may respond to ranging requested by the headend apparatus 100.

Next, at step S304, network time synchronization may be performed.

That is, at step S304, the headend apparatus 100 may perform network time synchronization after performing ranging.

At step S305, the terminal device 200 may perform clock synchronization.

That is, at step S305, the terminal device 200 may perform clock synchronization using information that is acquired from the downstream signal received from the CMTS 10.

At step S305, a local clock may be synchronized using the timestamp value contained in the synchronization message (SYNC message) of the downstream signal.

Next, at step S306, a MAP/UCD message may be parsed from the downstream signal.

That is, at step S306, the terminal device 200 may parse header information in the frame of a MAC management message of the downstream signal, and may acquire information for rescheduling of an upstream signal from a MAP/UCD message.

In this case, at step S306, channel information for receiving the upstream signal from the CM 20, preamble information corresponding to each burst type, and upstream bandwidth allocation information may be acquired from the downstream signal.

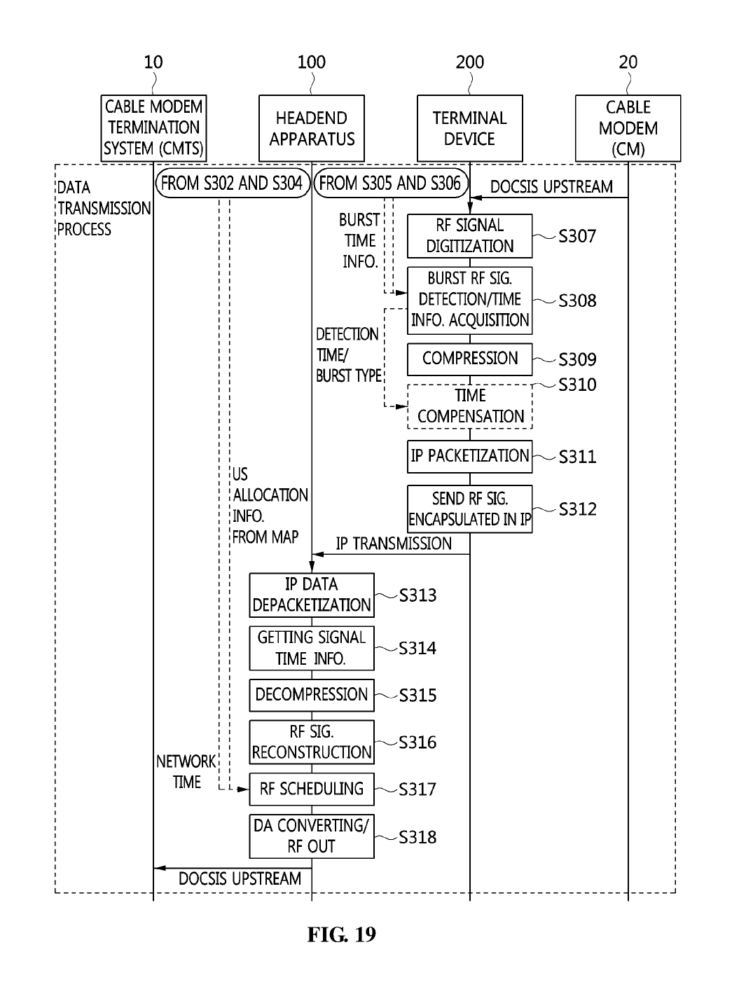

FIG. 19 is a sequence diagram illustrating a data transmission process according to an embodiment of the present invention.

Referring to FIG. 19, in the data transmission process according to the embodiment of the present invention, first, the terminal device 200 may receive an upstream signal from the CM 20, and may perform RF signal digitization on the received upstream signal at step S307.

That is, at step S307, the terminal device 200 may convert the upstream signal received from the CM 20 into an upstream RF burst signal, which is a digital signal.

Also, at step S308, an RF burst signal may be detected, and a burst type may be determined.

That is, at step S308, the digitized upstream RF burst signal may be detected from the digital signal using the preamble information (preamble pattern acquired from UCD), a burst type for the detection time may be determined, and a clock time may be acquired.

At step S309, compression may be performed.

That is, at step S309, the upstream RF burst signal may be compressed into a digital signal.

At step S310, time compensation may be performed.

Here, at step S310, the time at which the upstream RF burst signal is transmitted (transmitted time) may be estimated and compensated for using the burst type, the clock time, and the upstream bandwidth allocation information.

At step S311, IP packetization may be performed.

That is, at step S311, the upstream RF burst signal may be encapsulated into an IP packet.

Here, at step S311, the digitized upstream RF burst signal and the estimated transmitted time may be encapsulated into an IP packet.

Further, at step S312, the IP packet may be sent.

That is, at step S312, the IP packet may be sent to the headend apparatus 100.

At step S313, IP data depacketization may be performed.

That is, at step S313, the headend apparatus 100 may extract the upstream RF burst signal from the IP packet received from the terminal device 200.

Also, at step S314, time information may be acquired.

That is, at step S314, the time at which the upstream RF burst signal is transmitted (transmitted time) and the upstream bandwidth allocation information may be acquired from the IP packet.

At step S315, decompression may be performed.

That is, at step S315, the upstream RF burst signal, compressed into the digital signal in the IP packet, may be decompressed.

At step S316, the RF burst signal may be reconstructed.

That is, at step S316, the digitized upstream RF burst signal may be reconstructed.

At step S317, RF scheduling may be performed.

That is, at step S317, the time at which the upstream RF burst signal is to be sent to the CMTS 10 (sending time) may be scheduled based on the time at which the upstream RF burst signal is transmitted (transmitted time) and the upstream bandwidth allocation information.

At step S318, D/A conversion may be performed, and the RF burst signal may be transmitted.

That is, at step S318, the digitized upstream RF burst signal may be converted into an analog upstream RF signal, and an upstream signal corresponding to the analog upstream RF signal may be transmitted to the CMTS 10.

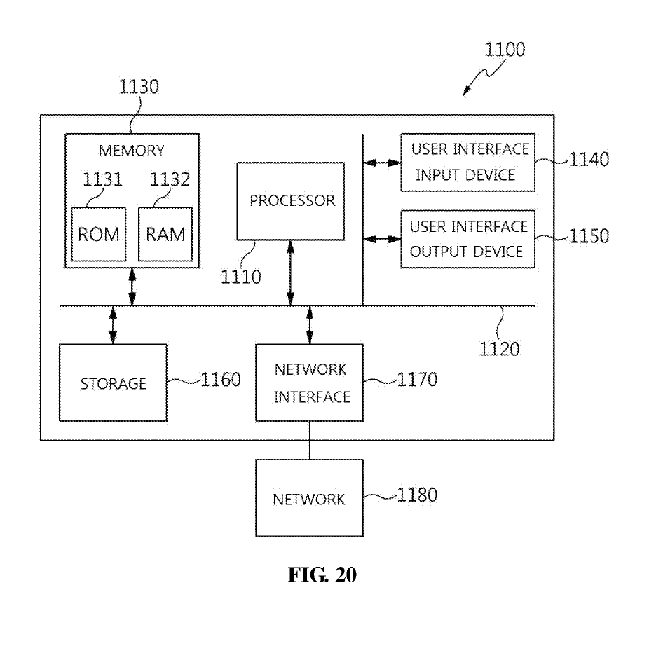

FIG. 20 is a diagram illustrating a computer system according to an embodiment of the present invention.

Referring to FIG. 20, the terminal device 200 and the broadcasting service provision apparatus (headend apparatus) 100 according to the embodiments of the present invention may each be implemented in a computer system 1100 such as a computer-readable storage medium. As illustrated in FIG. 20, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

The present invention may solve the problem of insufficient frequencies by providing a broadcast channel, on which a subscriber does not watch a broadcast, to a communication service.

Further, the present invention may provide a method for efficient management, control and operation between devices which provide broadcasting services in order to improve the efficiency of channel use.

Furthermore, the present invention may provide a cable broadcasting system that minimizes system construction expenses while using broadcasting equipment that is used by existing subscribers without change, even when a cable broadcasting network is changed to an optical cable network.

As described above, in the apparatus and method for providing a broadcasting service according to the present invention, the configurations and schemes in the above-described embodiments are not limitedly applied, and some or all of the above embodiments can be selectively combined and configured such that various modifications are possible.

What is claimed is:

1. An apparatus for providing a broadcasting service, comprising:
a checking unit for receiving a broadcasting service request from a subscriber and checking at least one of whether the subscriber is a new subscriber to a broadcast channel selected by the subscriber, whether a frequency of the broadcast channel is an idle frequency, and whether a service on the broadcast channel is an idle channel service; and
an assignment unit for assigning the subscriber to the frequency of the broadcast channel based on a result of checking at least one of whether the subscriber is a new subscriber, whether the frequency of the broadcast channel is an idle frequency, and whether the service on the broadcast channel is an idle channel service, and then providing a broadcasting service on the broadcast channel.

2. The apparatus of claim 1, wherein the checking unit is configured to check whether the subscriber is a new subscriber, and is configured to, when the subscriber is an existing subscriber, request the assignment unit to cancel assignment of a broadcast channel on which the existing subscriber is watching a broadcast, and check whether the frequency of the broadcast channel is an idle frequency.

3. The apparatus of claim 2, wherein the checking unit is configured to check whether the subscriber is a new subscriber, and is configured to, when the subscriber is a new subscriber, check whether the frequency of the broadcast channel is an idle frequency.

4. The apparatus of claim 3, wherein the checking unit is configured to check a subscriber count value of the broadcast channel, and is configured to, when the subscriber count value is 0, determine the frequency of the broadcast channel to be an idle frequency.

5. The apparatus of claim 4, wherein the assignment unit is configured to, when the frequency of the broadcast channel is an idle frequency, assign the subscriber to the broadcast channel, whereas when the frequency of the broadcast channel is not an idle frequency, check whether the service on the broadcast channel is an idle channel service.

6. The apparatus of claim 5, wherein the assignment unit is configured to, when the service on the broadcast channel is an idle channel service, terminate the idle channel service, and thereafter assign the subscriber to the broadcast channel, whereas when the service on the broadcast channel is not an idle channel service, assign the subscriber to the broadcast channel.

7. The apparatus of claim 6, wherein the assignment unit cancels the assignment of the subscriber to the broadcast channel by decreasing a subscriber count value previously assigned to the broadcast channel, and assigns the subscriber to the broadcast channel by increasing the subscriber count value previously assigned to the broadcast channel.

8. A method for providing a broadcasting service using a broadcasting service provision apparatus and a terminal device, the method comprising:
performing, by the broadcasting service provision apparatus and the terminal device, initialization using information acquired from a downstream signal received from a Cable Modem Termination System (CMTS);
converting, by the terminal device, an upstream signal received from a Cable Modem (CM) into a digital signal, encapsulating the digital signal into an IP packet, and transmitting the IP packet to the broadcasting service provision apparatus; and
extracting, by the broadcasting service provision apparatus, the digital signal from the IP packet received from the terminal device, converting the digital signal into an analog signal, and transmitting an upstream signal corresponding to the analog signal to the CMTS.

9. The method of claim 8, wherein performing the initialization comprises synchronizing, by the broadcasting service provision apparatus and the terminal device, a local clock using a timestamp value included in a synchronization message of the downstream signal.

10. The method of claim 9, wherein performing the initialization is configured such that each of the broadcasting service provision apparatus and the terminal device acquires, from the downstream signal, channel information for transmitting/receiving the upstream signal, preamble information corresponding to each burst type, and upstream bandwidth allocation information.

11. The method of claim 10, wherein transmitting the IP packet to the broadcasting service provision apparatus is configured to detect a digitized upstream RF burst signal from the digital signal using the preamble information, determine a burst type corresponding to a detection time, and acquire a clock time.

12. The method of claim 11, wherein transmitting the IP packet to the broadcasting service provision apparatus is configured to estimate a transmitted time at which the upstream RF burst signal is transmitted based on the burst type, the clock time, and the upstream bandwidth allocation information.

13. The method of claim 12, wherein transmitting the upstream signal corresponding to the analog signal to the CMTS is configured to extract the upstream RF burst signal from the IP packet, and acquire the transmitted time at which the upstream RF burst signal is transmitted and upstream bandwidth allocation information.

14. The method of claim 13, wherein transmitting the upstream signal corresponding to the analog signal to the CMTS is configured to schedule a sending time at which the upstream RF burst signal is to be sent to the CMTS, based on the transmitted time at which the upstream RF burst signal is transmitted and the upstream bandwidth allocation information.

15. The method of claim 14, wherein transmitting the upstream signal corresponding to the analog signal to the CMTS is configured to convert the upstream RF burst signal into an analog signal and transmit the upstream signal corresponding to the analog upstream RF burst signal to the CMTS.

16. A headend apparatus, comprising:
a headend initialization unit for performing initialization using information acquired from a downstream signal received from a Cable Modem Termination System (CMTS);
a headend signal-processing unit for extracting a digital signal from an IP packet received from a terminal device and converting the digital signal into an upstream signal corresponding to an analog signal; and
a communication unit for receiving the downstream signal from the CMTS, receiving the IP packet from the terminal device, and transmitting the upstream signal to the CMTS.

17. The headend apparatus of claim 16, wherein the headend initialization unit synchronizes a local clock using a timestamp value included in a synchronization message of the downstream signal.

18. The headend apparatus of claim 17, wherein the headend initialization unit acquires, from the downstream signal, channel information for transmitting the upstream signal, preamble information corresponding to each burst type, and upstream bandwidth allocation information.

19. The headend apparatus of claim 18, wherein the headend signal-processing unit extracts the upstream RF burst signal from the IP packet, and acquires a transmitted time at which the upstream RF burst signal is transmitted and the upstream bandwidth allocation information.

20. The headend apparatus of claim 19, wherein the headend signal-processing unit schedules a sending time at which the upstream RF burst signal is to be sent to the CMTS, based on the transmitted time at which the upstream RF burst signal is transmitted and the upstream bandwidth allocation information.
